(19) United States
(12) Patent Application Publication
(10) Pub. No.: US 2020/0288733 A1
(43) Pub. Date: Sep. 17, 2020

(54) DRIED FRUITS AND VEGETABLES WITH INCREASED AMOUNTS OF PROTEIN AND A JERKY-LIKE TEXTURE AND SYSTEMS AND METHODS FOR PRODUCING THE SAME

(71) Applicant: The Hershey Company, Hershey, PA (US)

(72) Inventors: Prashant Mudgal, Harrisburg, PA (US); Utkarsh Shah, Hummelstown, PA (US); Stephen Crozier, Hummelstown, PA (US)

(21) Appl. No.: 16/815,386

(22) Filed: Mar. 11, 2020

Related U.S. Application Data
(60) Provisional application No. 62/817,307, filed on Mar. 12, 2019.

(51) Int. Cl. A23B 7/02; A23B 7/06; A23L 31/00; A23L 33/19; A23B 7/08

(52) U.S. Cl. CPC A23B 7/0205; A23B 7/06; A23V 2002/00; A23L 33/19; A23B 7/085; A23L 31/00

(57) ABSTRACT

Dried fruits and vegetables with increased amounts of protein and a jerky-like texture are produced using systems and methods for blanching, marinating, draining and drying the fruits and vegetables. A marinade is prepared from proteins having a low molecular weight and high solubility, and protein is infused into the fruits and vegetables.

### TECHNICAL FIELD

The technical field relates generally to dried fruits and vegetables with increased amounts of protein and a jerky-like texture, and to systems and methods for producing the same.

### BACKGROUND

Fruits and vegetables have fiber, minerals, and vitamins. However, fruits and vegetables do not have much protein when compared to meat. For example, fruits and vegetables lack the protein content sought by conventional jerky consumers. Increasing the protein content of products that consist primarily of fruits and vegetables would therefore be advantageous.

Particularly, increasing the protein content of fruit and vegetable based snacks would result in a nutritious snack delivering protein, fiber, and micronutrients while being low in fat. However, infusing protein into plant tissue is difficult.

In addition, it can be difficult to get dried fruits and vegetables to have a jerky-like texture. For example, dried fruits and vegetables become shriveled and have a hard texture when dried below a certain water activity.

As such, it would be useful to have dried fruits and vegetables with increased amounts of protein and a jerky-like texture, and to have systems and methods for producing the same.

### SUMMARY

The various embodiments of the present disclosure provide dried fruits and vegetables with increased amounts of protein and a jerky-like texture, as well as systems and methods for producing the same.

By subjecting sliced or whole fruits and vegetables to blanching and adjusting the composition of a marinade, the protein content can be elevated through increased infusion—also referred to as uptake. In particular, the marinade composition is adjusted by selecting soluble proteins with relatively low molecular weights and high solubility and adjusting the pH of the marinade composition. The blanching and adjusted marinade produces whole fruit and vegetable jerky with protein content closer to conventional meat-based jerky.

In addition, upon drying, a jerky-like texture can be produced. In particular, by adjusting the sugar content of the marinade, a tender texture is maintained when the plant-based jerky is dried below a water activity (Aw or a_{w}) of 0.65. The water activity scale extends from 0 (bone dry) to 1.0 (pure water). Dried fruit is approximately 0.6.

Water in food which is not bound to food molecules can support the growth of bacteria, yeasts and molds (fungi). The term water activity (aw) refers to this unbound water. The water activity of a food is not the same thing as its moisture content. Although moist foods are likely to have greater water activity than are dry foods, this is not always so; in fact, a variety of foods may have exactly the same moisture content and yet have quite different water activities. The water activity (a_{w}) represents the ratio of the water vapor pressure of the food to the water vapor pressure of pure water under the same conditions and it is expressed as a fraction.

The foregoing has broadly outlined some of the aspects and features of the various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE FIGURES

FIG. 1 is a schematic view of a system for forming dried fruits and vegetables with increased amounts of protein and a jerky-like texture.

FIG. 2 is a flow chart of a process for forming dried fruits and vegetables with increased amounts of protein and a jerky-like texture.

FIG. 3 is a graph illustrating an increased amount of protein infusion using a marinade with a protein with a low molecular weight.

FIG. 4 is a graph illustrating an increased amount of protein infusion using a marinade with a protein with a high solubility.

FIG. 5 is a graph illustrating an increased amount of protein infusion using a marinade with an increased pH.

### DETAILED DESCRIPTION

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

In embodiments described in further detail below, the present disclosure describes dried fruits and vegetables with increased amounts of protein and a jerky-like texture and systems and methods for producing the same.

Systems and Processes

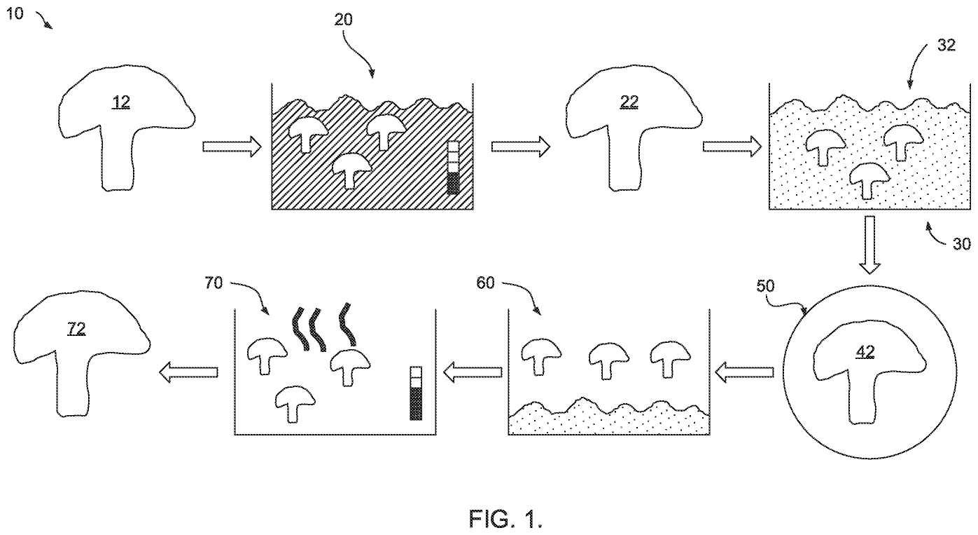

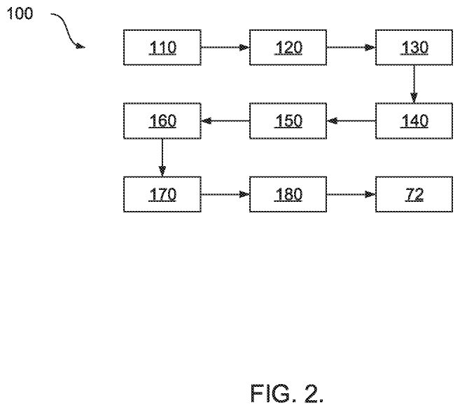

Referring to FIG. 1, an exemplary system 10 includes a hot water container 20, a marinade bath 30 including a marinade 32, a vacuum tumbler 50, a drainer 60, and a convection drier 70. For clarity, different numbers are used to identify a vegetable 12 at different stages of an exemplary process 100 (FIG. 2). In particular, the different stages include the vegetable 12, a blanched vegetable 22, a blanched marinated vegetable 42, and a dried marinated vegetable 72.

Referring to FIG. 2, the process 100 for forming dried fruits and vegetables with increased amounts of protein and a jerky-like texture is described. The process can be applied to fruits and vegetables including watermelon, mushrooms (e.g., portabella), coconuts, eggplant, gala apples, and the like. It is envisaged that the process can similarly be applied to other food sources.

The increase in protein infusion depends on the selected fruit or vegetable. For example, the protein infusion in apples was found to be lower than that of mushrooms. Cell structure and porosity of the fruit or vegetable may play an important role in the kinetics and extent of protein infusion.

For reference, on a w/w basis, the initial protein content of watermelon is 0.61%, the initial protein content of portabella mushrooms 3.3%, the initial protein content of coconut is 3.1-3.3%, the initial protein content of eggplant is 0.98%, and the initial protein content of gala apples is 0.26%. Protein infusion occurs to increase the protein content of the food source according to the processes described herein. In particular, the processes achieve an increase in protein content by increasing the amount of protein that is added through protein infusion.

Protein infusion may increase if the fruit or vegetable is cut or sliced, for example, because the overall surface area for proteins to infuse is increased.

Protein content is a measure of protein infusion. The protein content is a measure of the total amount of protein, which includes the protein already in the fruit or vegetable and the protein infused into the fruit or vegetable.

For purposes of describing the process 100, a vegetable is described. However, as mentioned above, the process is not limited to vegetables.

Referring to FIGS. 1 and 2, according to a preparation step 110, a vegetable 12 is prepared. For example, preparation can include cutting or slicing the vegetable to a selected piece size. In certain embodiments, whole vegetables are used.

According to a blanching step 120, the prepared vegetables 12 are blanched in the hot water container 20, resulting in blanched vegetables 22. For example, the vegetables are held in the hot water container 20 at a temperature of 211 degrees Fahrenheit for a time of 45 seconds. The temperature and time depends on the fruit or vegetable. For example, temperatures can range from 185 degrees Fahrenheit to 211 degrees Fahrenheit and times can be up to seven minutes.

According to a post-blanching step 130, excess water is drained and the blanched vegetables 22 are placed in a freezer (not shown) for ten minutes to bring the temperature of the blanched vegetables 22 down.

According to a marinade preparation step 140, a marinade 32 is prepared. According to an exemplary embodiment, the marinade 32 includes a protein with a low molecular weight and a high solubility. For example, exemplary proteins include algae protein, whey protein, egg white protein, canola protein, whey protein isolate (WPI), pea protein, soluble beverage grade pea proteins, and proteins with similar molecular weight and solubility. Exemplary proteins and their molecular weights and solubility are shown in Table 2 below.

According to an exemplary embodiment, the marinade 32 includes syrup (sugar), protein, seasoning, and water. For example, the protein may be 12-22% of the marinade 32 on w/w basis (mass fraction) and the sugar may be 10-50% of the marinade 32 on w/w basis.

In exemplary embodiments, the marinade 32 is prepared with a selected pH. For, example, the marinade 32 is prepared to have a pH of 8. The pH can be adjusted using a 50% solution on a w/w basis of food grade Sodium Hydroxide (NaOH). In general, because solubility of proteins increases away from their isoelectric points (e.g., between 4 and 6), alkaline pH will make proteins more soluble. However, for purposes of taste and texture, it may not be advisable to increase pH beyond a certain point. As a non-limiting example, a pH in the range of 6 to 9 could be suitable for this application.

In exemplary embodiments, the marinade 32 is prepared to have a sugar content of 10-50% on w/w basis.

According to a marinating step 150, the blanched vegetables 22 are soaked in the marinade 32 in the marinade bath 30 overnight (e.g., for 16 hours) at 4 degrees Celsius, resulting in blanched marinated vegetables 42.

According to a vacuum tumbling step 160, the blanched marinated vegetables 42 are rotated in a vacuum tumbler 50 at 4 millimeters of mercury (mm-Hg) and 6 rotations per minute (rpm) for 1 hour. Vacuum tumbling reduces the soak time of the marination step 150. In particular, approximately the same protein content can alternatively be achieved without vacuum tumbling, for example, by extending the soak time of the marinating step 150 to 43 hours. For reference, example results of using a 43 hour soak and example results of an overnight soak with vacuum tumbling are shown in Table 2 below.

According to a draining step 170, excess marinade is drained from the tumbled blanched marinated vegetables 42 by a drainer 60.

According to a drying step 180, the tumbled blanched marinated vegetables 42 are dried in a convection drier 70 at a temperature of 160 degrees Fahrenheit until the blanched marinated vegetables 42 reach a water activity of less than 0.65, resulting in dried marinated vegetables 72. For example, the blanched marinated vegetables 42 are dried to a water activity between 0.6 and 0.65.

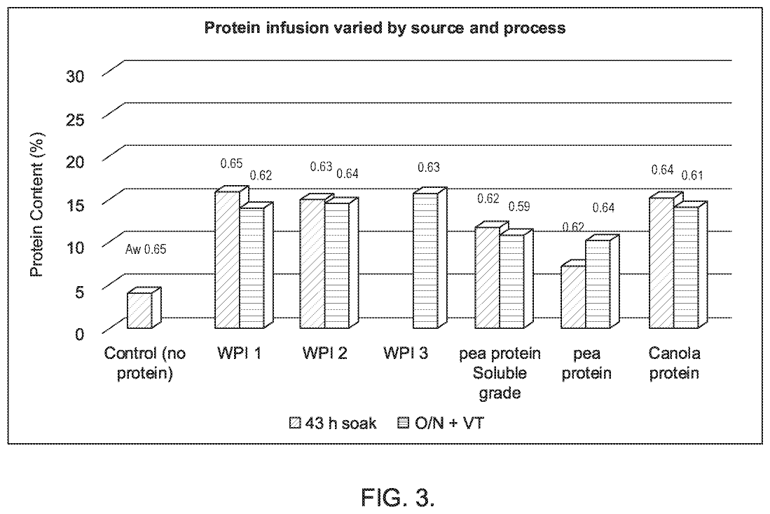

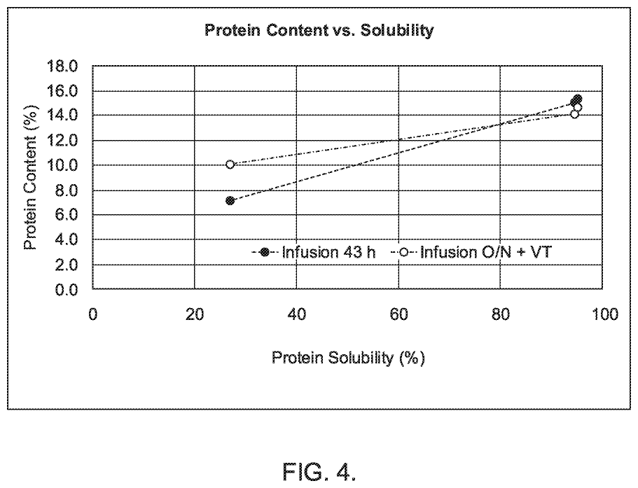

Referring to FIGS. 3-4, the increased protein infusion during the marination step 150 is described in further detail with respect to blanching, protein selection, and pH selection. In general, when dried to approximately the same water activity, fruits and vegetables demonstrate an increased percentage of protein content when blanching is performed and the marinade composition has a selected protein and pH.

Blanching

Referring to Table 1, trials used different vegetables, proteins, and included or excluded the blanching step to create dried marinated vegetables according to the process 100. In the marinade formulations, the protein is 22% of the marinade 32 and the sugar is 36% of the marinade 32 on w/w basis. The composition of the marinade 32 was kept constant, with the exception of the protein component. The dried marinated vegetables 72 were dried to a water activity in a range of 0.29 to 0.62.

TABLE 1
Blanching Variation

| | | | Protein Content | Water Activity |
|---|---|---|---|---|
| Vegetable | Protein | Blanching? | (%) | (Aw) |
| Mushroom | Algae | No | 15.6 | 0.59 |
| Mushroom | Algae | Yes | 16.7 | 0.62 |
| Mushroom | Whey | No | 25.1 | 0.4 |
| Mushroom | Whey | Yes | 23.1 | 0.6 |
| Eggplant | Algae | No | 11.8 | 0.43 |
| Eggplant | Algae | Yes | 11.8 | 0.61 |
| Eggplant | Whey | No | 13.0 | 0.29 |
| Eggplant | Whey | Yes | 18.9 | 0.5 |

Table 1 shows a measured protein content percentage. As the base amount of protein in a fruit or vegetable is relatively constant, differences in protein content reflect varying degrees of protein infusion. As such, a higher percentage of protein content indicates that more infusion has occurred.

The blanching step 120 increases the amount of protein infusion into the blanched vegetables 22 during the marination step 150. For example, for approximately the same water activity, the protein content (representative of algae protein infusion) of the mushroom increased from 15.6% to 16.7% when the blanching step 120 was included.

Protein concentration increases as water activity goes down. For the eggplant with the algae protein, the blanching step 120 yields the same protein content at a higher water activity, and would provide more protein content were the water activity the same.

Alternatively described, because water activity generally relates to moisture content, a given amount of protein will constitute a higher concentration in the fruit or vegetable when the moisture content is lower.

Although the amount of infusion varies based on the protein source, blanching improves the amount of protein infusion. This improvement may be realized because blanching may change or open up cell structure, thereby making it more accessible to protein by infusion.

Protein Molecular Weight and Solubility Examples

Referring to Table 2, marinade formulations using different proteins were used to create dried marinated mushrooms 72 according to the process 100. In the marinade formulations, the protein is 12.8% of the marinade 32 and the sugar is 49% of the marinade 32 on w/w basis. The composition of the marinade 32 is kept constant, other than the choice of protein. The dried marinated mushrooms 72 were dried to a water activity in a range of 0.59 to 0.64.

TABLE 2
Protein Molecular Weight and Solubility Variation

| | | | Protein | Protein | |
|---|---|---|---|---|---|
| | Molecular | | Content | Content | Water |
| | Weight | Solubility | (%) 43 h | (%) | Activity |
| Protein | (kDa) | (%) | soak | O/N + VT | (Aw) |
| WPI1 | ~80% of | ~95% | 15.7 | 14.0 | 0.62 |
| WPI2 | protein less | | 15.0 | 14.6 | 0.64 |
| WPI3 | than 20 kDa | | N/A | 15.7 | 0.63 |
| Pea Protein | N/A | N/A | 11.7 | 10.7 | 0.59 |
| Soluble | | | | | |
| Grade | | | | | |
| Pea protein | 50% protein | 27.2% | 7.1 | 10.0 | 0.64 |
| | greater than | | | | |
| | 150 kDa | | | | |
| Canola | Majority of | 94.4% | 15.0 | 14.1 | 0.61 |
| Protein | protein less | | | | |
| | than 20 kDa | | | | |

In Table 2, the protein component of each marinade 32 is a mixture of proteins, and the molecular weight of the mixture is represented by the molecular weight of a majority of the proteins in the mixture. Although a specific molecular weight and solubility is not provided for soluble grade pea protein, the molecular weight is less than regular pea protein and solubility is higher than regular pea protein.

In addition, solubility can change under the conditions measured such as pH, salt concentration, and temperatures.

The increase in protein infusion with respect to molecular weight and solubility is illustrated in FIGS. 3 and 4. Here, lower molecular weight and/or higher solubility results in greater protein infusion. Low molecular weight can be characterized as at least 50% of the protein having a molecular weight of less than 100 kDa and more specifically as at least 80% of the protein having a molecular weight of less than 20 kDa. High solubility can be characterized as the protein having a solubility of 50% or more.

With reference to FIG. 3 and Table 2, the proteins with lower molecular weight (i.e., WPI1, WPI2, WPI3 and Canola Protein, which have a majority of protein having a molecular weight of less than 20 kDa) resulted in greater protein infusion (e.g., protein content is 4-5% more) than the proteins with higher molecular weight (i.e., Pea Protein, with 50% of the protein having a molecular weight that is greater than 150 kDa).

With reference to FIG. 4, higher solubility (e.g., 94-95%) resulted in greater protein infusion (e.g., protein content is 4-5% more) than lower solubility (e.g., 27%).

pH Examples

Referring to Table 3, marinade formulations using different levels of pH and different proteins were used to create dried marinated mushrooms 72 according to the process 100. In the marinade formulations, the protein is 15.7% of the marinade 32 and the sugar is 22.8% of the marinade 32 on w/w basis. The composition of the marinade 32 is kept constant, other than the protein selected. The dried marinated mushrooms 72 were dried to a water activity in a range of 0.59 to 0.64.

TABLE 3
pH Variation

| Protein | pH | Protein Content (%) | Water Activity (Aw) |
|---|---|---|---|
| WPI2 | Native (6.1) | 14.3 | 0.65 |
| WPI2 | 8 | 20.1 | 0.64 |
| Canola Protein | Native (7.0) | 15.8 | 0.65 |
| Canola Protein | 8 | 17.8 | 0.61 |

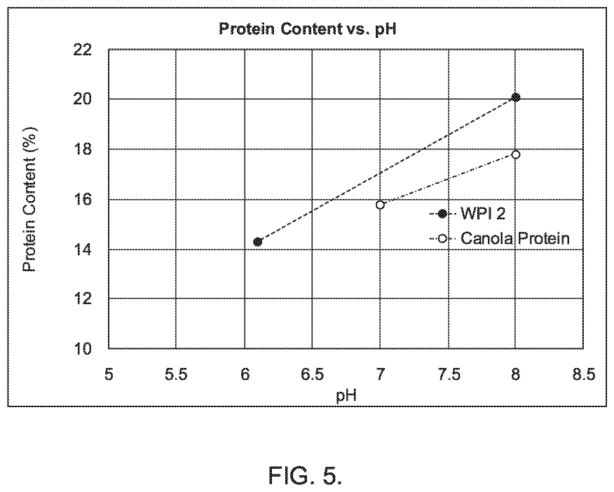

The increase in protein infusion with respect to pH level is illustrated in FIG. 5. Here, a pH of 8 results in greater protein infusion (e.g., 2-5% more protein content) than a pH of 6.1 or 7. Referring to FIG. 5 and Table 3, the more alkaline pH of 8 makes the proteins more soluble and increases the protein infusion.

Texture: Water Activity and Sugar

The water activity affects the texture of the dried marinated vegetables. For example, drying the vegetables to a low water activity increases the toughness of the dried marinated vegetables.

In addition, the texture of the dried marinated vegetables can be changed by varying the sugar content at equal water activity. In particular, the texture of the dried marinated vegetables can be changed from chewy to hard or tough by decreasing the amount of sugar in the marinade.

Referring to Table 2 and Table 3 above, the sugar content of the dried marinated mushrooms of Table 2 was 49% on a w/w basis, while the sugar content of the dried marinated mushrooms of Table 3 was 23% on a w/w basis. The dried marinated mushrooms associated with Table 3 were less chewy than the dried marinated mushrooms associated with Table 2. Further reducing the sugar content to 11% led to faster drying of the product and even firmer textures. As a non-limiting example, sugar content in a range of 20-50% of a marinade on a w/w basis provides a preferred texture.

The above-described embodiments are merely exemplary illustrations of implementations that are set forth for a clear understanding of principles. Variations, modifications, and combinations may be made to the above-described embodiments may be made without departing from the scope of the claims. All such variations, modifications, and combinations are included herein by the scope of this disclosure and the following claims.

1. A method, comprising:
blanching a food source comprising a fruit or vegetable to produce a blanched food source;
marinating the blanched food source in a marinade to produce a marinated food source, the marinade comprising a protein having at least one of low molecular weight and high solubility; and
drying the marinated food source to produce a dried food source.

2. The method of claim 1, performing the blanching step within a temperature range from 185 degrees Fahrenheit to 211 degrees Fahrenheit.

3. The method of claim 1, performing the blanching step for no longer than seven minutes.

4. The method of claim 1, wherein the protein is 12-22% of the marinade on w/w basis.

5. The method of claim 4, wherein sugar is 20-50% of the marinade on w/w basis.

6. The method of claim 1, wherein a pH of the marinade is in a range of 8 to 9.

7. The method of claim 1, wherein the drying step comprises drying the marinated food source to produce the dried food source having a water activity of less than 0.65.

8. The method of claim 1, wherein the drying step comprises drying the marinated food source to produce the dried food source having a water activity in a range of 0.6 to 0.65.

9. The method of claim 1, wherein the protein has a molecular weight of less than 100 kDa.

10. The method of claim 1, wherein at least 50% of the protein has a molecular weight of less than 100 kDa.

11. The method of claim 1, wherein the protein has a molecular weight of less than 20 kDa.

12. The method of claim 1, wherein at least 80% of the protein has a molecular weight of less than 20 kDa.

13. The method of claim 1, wherein the protein has a solubility of greater than 50%.

14. The method of claim 1, wherein the protein has a solubility of greater than 90%.

15. The method of claim 1, wherein the protein is whey.

16. The method of claim 1, wherein the food source is mushrooms.
